(19) United States
(12) Patent Application Publication
(10) Pub. No.: US 2025/0099988 A1
(43) Pub. Date: Mar. 27, 2025

(54) WATER FLOW SWITCHING DEVICE FOR SPRINKLER APPLICATIONS

(71) Applicant: Cheng-Yu LAI, Changhua City, Changhua County (TW)

(72) Inventors: Cheng-Yu LAI, Changhua City (TW); Ching-Hao CHAN, Taipei City (TW)

(21) Appl. No.: 18/475,457

(22) Filed: Sep. 27, 2023

(51) Int. Cl. B05B 3/14; B05B 12/32

(52) U.S. Cl. CPC B05B 3/14; B05B 12/32

(57) ABSTRACT

Disclosed is a water flow switching device for sprinkler applications, the features of which include a projecting swing arm having a driven end, an oscillating end, and a supporting flange. The driven end extends to the exterior of an end wall and corresponding to a spray angle control mechanism to form a driven relationship. The oscillating end being located in a gear chamber. The supporting flange is mounted on a pivot seat. The oscillating end includes a first and a second oscillating position. A water shut-off device is disposed in the gear chamber. One side of the device has a first flap end, a second flap end, and a snap-over portion. A pivot joint is provided between an assembly end of the water shut-off device and the oscillating end, including a convex portion and a concave portion for nesting and pivoting with each other

### FIELD OF THE INVENTION

The present invention relates to a water flow switching device. More particularly, it relates to an innovative structural design of a water flow switching device for sprinkler applications as disclosed herein.

### BACKGROUND OF THE INVENTION

Currently, in the structural design of conventional sprinklers, it is customary to employ a water flow switching device to control and adjust the angle range of the water spray.

The conventional water flow switching devices mainly consist of two primary types, the seesaw plate and the oscillating rod. However, regardless of the type chosen, practical experience has revealed certain issues and shortcomings. One common issue is the complexity of component assembly, which leads to inconvenience during assembly and escalates production costs, including both manufacturing processes and material costs. In addition, there is another issue of component actions that are not precisely aligned during the switching process. This misalignment prevents effective redirection of the water flow, resulting in a significant reduction in service life. Overcoming these challenges is an important engineering endeavor that deserves the attention and breakthroughs of the relevant industries.

### BRIEF SUMMARY OF THE INVENTION

The main purpose of the present invention is to introduce an innovative water flow switching device for sprinkler applications. The central technical challenge it seeks to address revolves around the development of a novel sprinkler water flow switching structure optimized for practical utility. This pursuit is driven by the aspiration to achieve innovative breakthroughs and create a more ideal solution for the intended purpose.

In light of the foregoing purpose, the technical features of the present invention for solving the problem are mainly as follows.

The water flow switching device is situated within a confining casing of a sprinkler control module, this confining casing is characterized by the presence of a partition dividing the confining casing into a gear chamber and a reversing impeller chamber; the partition is formed with a first passage and a second passage providing communication between the gear chamber and the reversing impeller chamber; in addition, an oscillation positioning portion is disposed between the first passage and the second passage within the partition; the gear chamber also includes an end wall which is spaced apart from the partition, this end wall is provided with a spray angle control mechanism on its outside, and a pivot seat is provided inside of the gear chamber.

The water flow switching device comprises a projecting swing arm, having a driven end, an oscillating end, and a supporting flange between the driven end and the oscillating end, wherein the driven end extends to the exterior of the end wall and corresponds to the spray angle control mechanism to form a driven relationship, the oscillating end is located in the gear chamber, and the supporting flange is mounted on the pivot seat allowing the oscillating end to swing on such pivot seat as a pivot point, including a first oscillating position and a second oscillating position.

A water shut-off device, is disposed in the gear chamber, one side of the water shut-off device including a first flap end, a second flap end, and a snap-over portion between the first flap end and the second flap end, wherein the first flap end corresponds to the first passage, the second flap end corresponds to the second passage, and the snap-over portion corresponds to the oscillation positioning portion; and the other side of the water shut-off device is formed with an assembly end.

A pivot joint, is provided between the assembly end of the water shut-off device and the oscillating end of the projecting swing arm.

The pivot joint comprises a convex portion and a concave portion which are nested and pivotable with each other, and the projecting of the convex portion and the projecting of the projecting swing arm are in an orthogonal relationship with each other; by means of the pivot joint, when the oscillating end of the projecting swing arm is in the first oscillating position, it operates the first flap end of the water shut-off device to press against and close the first passage, and when the oscillating end is in the second oscillating position, it operates the second flap end of the water shut-off device to press against and close the second passage.

The effects and advantages of the present invention are mainly focused on optimizing the water flow switching device for sprinklers to achieve streamlining of components, reducing manufacturing, assembly, and material costs. It also ensures precise alignment of component actions. Ultimately, these advantages combine to effectively extend the life of the sprinkler, enhance its industrial applicability and constitute a significant inventive step in the field.

Another purpose of the present invention is provided with another feature that the water shut-off device comprises two elastic arms in a bifurcated configuration, allowing the first flap end and the second flap end to be coupled to the ends of the two elastic arms, respectively, thereby allowing the first flap end or the second flap end to obtain a tighter sealing effect when they perform the sealing action.

A further purpose of the present invention is provided with a further feature that the pivot joint comprises two elastic clips which are symmetrically configured at intervals, the two elastic clips being connected to the assembly end of the water shut-off device and being elastically pressed against the two sides of the oscillating end of the projecting swing arm to produce a certain degree of elasticity which constraints the pivoting action of the pivot joint, so as to enhance its industrial applicability and constitute a significant inventive step in the field.

An additional purpose of the present invention is provided with an additional feature that two profiled grooves are formed on both sides of the snap-over portion of the water shut-off device, and an elastic board is formed between the two profiled grooves constituting the snap-over portion on the structure of the elastic board to enhance the flexibility of the snap-over action of the snap-over portion.

### BRIEF DESCRIPTION OF THE SEVERAL VIEWS OF THE DRAWINGS

FIG. 1 is an assembled three-dimensional view of a preferred embodiment of the present invention.

FIG. 2 is a disassembled three-dimensional view of the main components of a preferred embodiment of the present invention.

FIG. 3 is a disassembled three-dimensional view of a preferred embodiment of the water flow switching device of the present invention.

FIG. 4 is a cross-sectional view of a preferred embodiment of the present invention with the oscillating end in the first oscillating position.

FIG. 5 is a schematic diagram of the water flow switching state of the passage corresponding to FIG. 4, with line 4-4 in this figure indicating a cross-section shown in FIG. 4.

FIG. 6 is a cross-sectional view of a preferred embodiment of the present invention with the oscillating end in the first oscillating position.

FIG. 7 is a schematic diagram of the water flow switching state of the passage corresponding to FIG. 6, with line 6-6 in this figure indicating a cross-section shown in FIG. 6.

FIG. 8 is a schematic diagram of the present invention with an angle between the first and second flap ends.

### DETAILED DESCRIPTION OF THE INVENTION

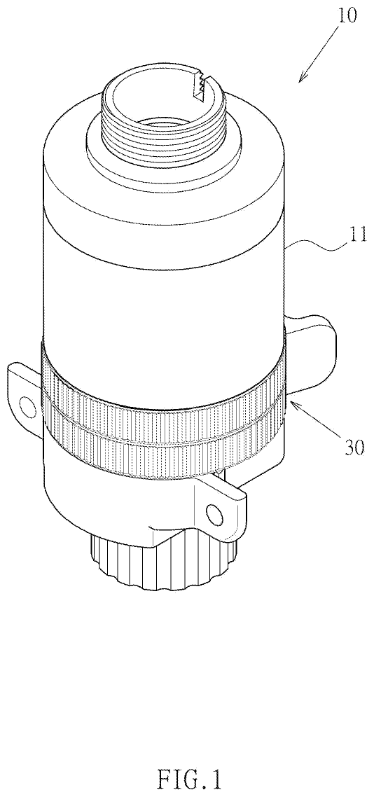

Reference is made to FIGS. 1 through 8 for a preferred embodiment of a water flow switching device for sprinkler applications of the present invention. However, it is important to note that this embodiment is for illustrative purposes only and does not limit the structure in the context of the patent applications.

A water flow switching device 100 is situated within a confining casing 11 of a sprinkler control module 10. This confining casing 11 is characterized by the presence of a partition 12 dividing the confining casing 11 into a gear chamber 13 and a reversing impeller chamber 14. The partition 12 is formed with a first passage 21 and a second passage 22 providing communication between the gear chamber 13 and the reversing impeller chamber 14. In addition, there is an oscillation positioning portion 23 disposed between the first passage 21 and the second passage 22 within the partition 12. The gear chamber 13 also includes an end wall 15 which is spaced apart from the partition 12, this end wall 15 is provided with a spray angle control mechanism 30 on its outside, and a pivot seat 16 is provided inside of the gear chamber 13. The water flow switching device 100 comprises: a projecting swing arm 40 having a driven end 41, an oscillating end 42, and a supporting flange 43 between the driven end 41 and the oscillating end 42, wherein the driven end 41 extends to the exterior of the end wall 15 and corresponds to the spray angle control mechanism 30 to form a driven relationship; the oscillating end 42 is located in the gear chamber 13, and the supporting flange 43 is mounted on the pivot seat 16 allowing the oscillating end 42 to swing on such pivot seat 16 as a pivot point, including a first oscillating position and a second oscillating position. A water shut-off device 50 is disposed in the gear chamber 13, one side of the water shut-off device 50 including a first flap end 51, a second flap end 52, and a snap-over portion 53 between the first flap end 51 and the second flap end 52, wherein the first flap end 51 corresponds to the first passage 21, the second flap end 52 corresponds to the second passage 22, and the snap-over portion 53 corresponds to the oscillation positioning portion 23, and the other side of the water shut-off device 50 is formed with an assembly end 54. A pivot joint 60 is provided between the assembly end 54 of the water shut-off device 50 and the oscillating end 42 of the projecting swing arm 40, the pivot joint 60 comprises a convex portion 61 and a concave portion 62 which are nested and pivotable with each other, and the projecting axis X of the convex portion 61 and the projecting axis Y of the projecting swing arm 40 are in an orthogonal relationship with each other. By means of the pivot joint 60, when the oscillating end 42 of the projecting swing arm 40 is in the first oscillating position, it operates the first flap end 51 of the water shut-off device 50 to press against and close the first passage 21, and when the oscillating end 42 is in the second oscillating position, it operates the second flap end 52 of the water shut-off device 50 to press against and close the second passage 22.

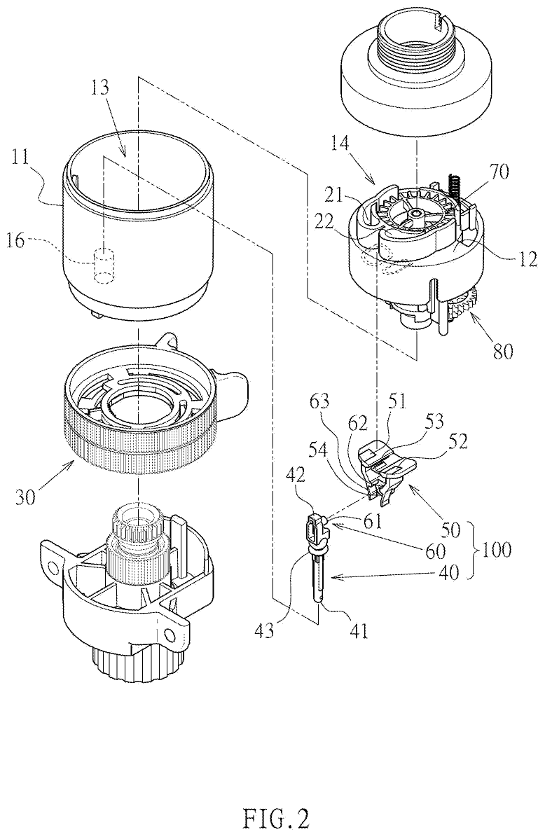

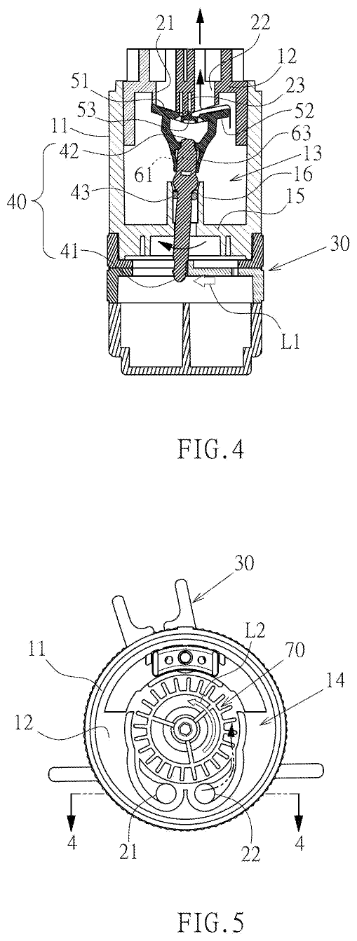

Using the above structural configuration and technical features, the water flow switching device for sprinkler applications disclosed in the present invention is shown in FIGS. 4 and 5. When the driven end 41 of the projecting swing arm 40 is pushed against by the spray angle control mechanism 30 (as shown by Arrow No. L1), which results in the oscillating end 42 being positioned in the first oscillating position, and which can be linked up the first flap end 51 of the water shut-off device 50 to press against and seal the first passage 21 by means of the pivot joint 60, at which time the second passage 22 introduces water into the reversing impeller chamber 14 to drive the impeller 70 therein to rotate in a counterclockwise direction (as shown by Arrow No. L2), and the impeller 70 drives a variable speed gear set 80 (as shown in FIG. 2) installed in the gear chamber 13, which in turn drives the confining casing 11 to rotate.

During this process, the relative angular orientation of the confining casing 11 and the spray angle control mechanism 30 will be changed, and when the confining casing 11 is rotated to a predetermined position of the spray angle control mechanism 30, the driven end 41 of the projecting swing arm 40 will be in a state to be pushed against by the water spray angle control mechanism 30 accordingly.

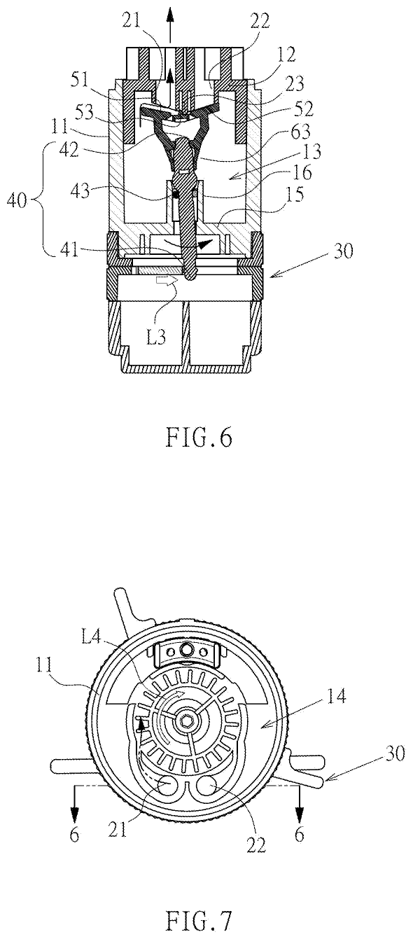

Since the transmission relationship between the impeller 70, the variable speed gear set 80, and the spray angle control mechanism 30 described herein is within to the scope of the prior art and has many specific implementations in sprinklers, which are not within the scope of the present invention, so it will not be described in detail. Then, as shown in FIGS. 6 and 7, when the driven end 41 of the projecting swing arm 40 is pushed against by the spray angle control mechanism 30 (as shown by Arrow No. L3), which results in the oscillating end 42 is positioned in the second oscillating position, and which can be linked up the second flap end 52 of the water shut-off device 50 to press against and seal the second passage 22 by means of the pivot joint 60, at which time the first passage 21 introduces water into the reversing impeller chamber 14 to drive the impeller 70 therein to rotate in a clockwise direction (as shown by Arrow No. L4), thereby achieving the functional requirement of switching the water flow. Furthermore, in the above operating state, regardless of whether the oscillating end 42 reaches the first or second oscillating position, the snap-over portion 53 will perform a snap-over action with the oscillation positioning portion 23, thereby creating a degree of positioning effect. The water flow switching device of the present invention, as compared to the prior art, has a significantly more compact structure consisting only of the projecting swing arm 40 and the water shut-off device 50 by means of the pivot joint 60. This results in significant reductions in manufacturing processes, assembly complexity, and material costs. In addition, the characteristic of the linkage configuration of the convex portion 61 and the concave portion 62 of the pivot joint 60, which makes the switching action more precise, and the characteristic that the pivot joint 60 is capable of pivoting to cope with contingencies can effectively avoid the problem that the conventional structure does not work in alignment (e.g., jamming, incomplete closing). As a result, this structure advantageously ensures precise switching of the water flow and prolongs the service life of the device.

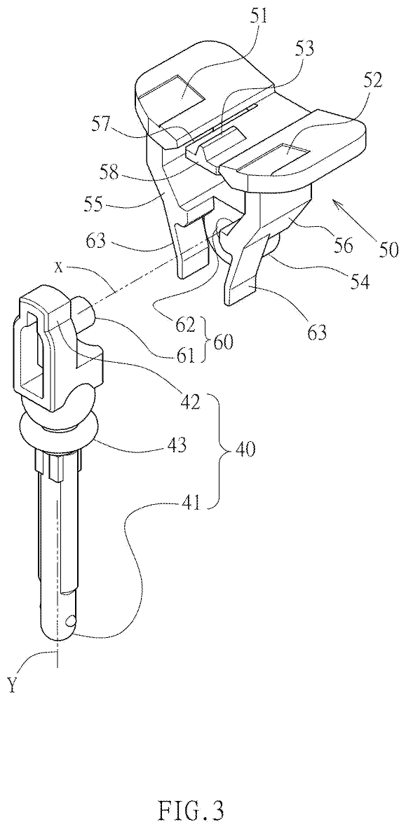

As shown in FIG. 3, in this embodiment, the water shut-off device 50 further includes two elastic arms 55, 56 in a bifurcated configuration, allowing the first flap end 51 and the second flap end 52 to be coupled to the ends of the two elastic arms 55, 56, respectively. By this implementation, when the first flap end 51 or the second flap end 52 performs the sealing action, it is possible to obtain a tighter effect due to a better elastic support property of the two elastic arms 55, 56.

As shown in FIG. 3, in this embodiment, the pivot joint 60 further includes two elastic clips 63 which are symmetrically configured at intervals, the two elastic clips 63 being connected to the assembly end 54 of the water shut-off device 50 and being elastically pressed against the two sides of the oscillating end 42 of the projecting swing arm 40 to produce a certain degree of elasticity which constrains the pivoting action of the pivot joint 6; the advantage of this is that whether the first flap end 51 of the water shut-off device 50 is pressed against the first passage 21 or the second flap end 52 is pressed against the second passage 22, the two elastic clips 63 can utilize an elastic constraining effect on the pivot joint 60 to increase the elastic pushing effect and make it more tight and secure.

As shown in FIG. 3, in this embodiment, two profiled grooves 57 are formed on both sides of the snap-over portion 53 of the water shut-off device 50, and an elastic board 58 is formed between the two profiled grooves 57 and constitutes the snap-over portion 53 on the structure of the elastic board 58 to enhance the flexibility of the snap-over action of the snap-over portion 53, thereby effectively avoiding the problem of spanning difficulties during the process of sticking the snap-over portion 53 over the counterpart of the oscillation positioning portion 23 to obtain a relatively smoother and better snap-over action.

As shown in FIG. 3, in this embodiment, the convex portion 61 of the pivot joint 60 is in the form of a shaft structure, and the concave portion 62 is in the form of a shaft hole that is compatible with the convex portion 61 to be sleeved and rotated.

As shown in FIG. 3, in this embodiment, the pivot seat 16 of the gear chamber 13 is a hollow tube shape, and the oscillating supporting flange 43 is formed as an elastic ring and mounted on the pivot seat 16 to achieve an effect of being able to oscillate along with an effect of being watertight.

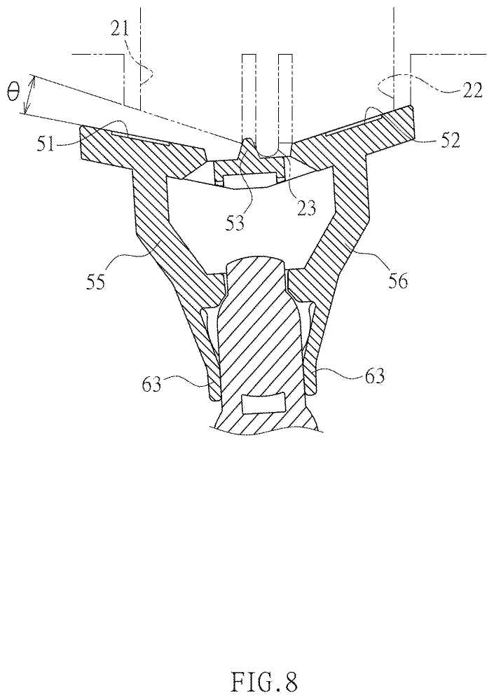

As shown in FIG. 8, in this embodiment, an angle θ is formed between the first flap end 51 and the first passage 21 in an unsealed state, and the angle θ is in the range of 5 degrees to 12 degrees; meanwhile, the second flap end 52 has the same corresponding relationship with the second passage 22.

I claim:

1. A water flow switching device for sprinkler applications, wherein the water flow switching device is situated within a confining casing of a sprinkler control module, this confining casing is characterized by the presence of a partition dividing the confining casing into a gear chamber and a reversing impeller chamber; the partition is formed with a first passage and a second passage providing communication between the gear chamber and the reversing impeller chamber; in addition, an oscillation positioning portion is disposed between the first passage and the second passage within the partition; the gear chamber also includes an end wall which is spaced apart from the partition, this end wall is provided with a spray angle control mechanism on its outside, and a pivot seat is provided inside of the gear chamber; the water flow switching device comprising:
a projecting swing arm having a driven end, an oscillating end, and a supporting flange between the driven end and the oscillating end, wherein the driven end extends to the exterior of the end wall and corresponds to the spray angle control mechanism to form a driven relationship, the oscillating end is located in the gear chamber, and the supporting flange is mounted on the pivot seat 16 allowing the oscillating end to swing on such pivot seat as a pivot point, including a first oscillating position and a second oscillating position;
a water shut-off device disposed in the gear chamber, one side of the water shut-off device including a first flap end, a second flap end, and a snap-over portion between the first flap end and the second flap end, wherein the first flap end corresponds to the first passage, the second flap end corresponds to the second passage, and the snap-over portion corresponds to the oscillation positioning portion; and the other side of the water shut-off device is formed with an assembly end;
a pivot joint provided between the assembly end of the water shut-off device and the oscillating end of the projecting swing arm; the pivot joint comprises a convex portion and a concave portion which are nested and pivotable with each other, and the projecting axis X of the convex portion and the projecting axis Y of the projecting swing arm are in an orthogonal relationship with each other; by means of the pivot joint, when the oscillating end of the projecting swing arm is in the first oscillating position, it operates the first flap end of the water shut-off device to press against and close the first passage, and when the oscillating end is in the second oscillating position, it operates the second flap end of the water shut-off device to press against and close the second passage.

2. The water flow switching device for sprinkler applications according to claim 1, wherein the water shut-off device further includes two elastic arms, in a bifurcated configuration, allowing the first flap end and the second flap end to be coupled to the ends of the two elastic arms, respectively.

3. The water flow switching device for sprinkler applications according to claim 1, wherein the pivot joint further includes two elastic clips which are symmetrically configured at intervals, the two elastic clips being connected to the assembly end of the water shut-off device and being elastically pressed against the two sides of the oscillating end of the projecting swing arm to produce a certain degree of elasticity which constrains the pivoting action of the pivot joint.

4. The water flow switching device for sprinkler applications according to claim 1, wherein two profiled grooves are formed on both sides of the snap-over portion of the water shut-off device, and an elastic board is formed between the two profiled grooves and constitutes the snap-over portion on the structure of the elastic board to enhance the flexibility of the snap-over action of the snap-over portion.

5. The water flow switching device for sprinkler applications according to claim 1, wherein the convex portion of the pivot joint is in the form of a shaft structure, and the concave portion is in the form of a shaft hole that is compatible with the convex portion to be sleeved and rotated.

6. The water flow switching device for sprinkler applications according to claim 1, wherein the pivot seat of the gear chamber is a hollow tube shape, and the oscillating supporting flange is formed as an elastic ring and mounted on the pivot seat to achieve an effect of being able to oscillate along with an effect of being watertight.

7. The water flow switching device for sprinkler applications according to claim 1, wherein an angle θ is formed between the first flap end and the first passage in an unsealed state, and the angle θ is in the range of 5 degrees to 12 degrees, and the second flap end has the same corresponding relationship with the second passage.
